(19) United States
(12) Patent Application Publication
(10) Pub. No.: US 2025/0054227 A1
(43) Pub. Date: Feb. 13, 2025

(54) MULTI-LAYER AND FINE-GRAINED INPUT ROUTING FOR EXTENDED REALITY ENVIRONMENTS

(71) Applicant: Meta Platforms, Inc., Menlo Park, CA (US)

(72) Inventors: Michael Ishigaki, Mountain View, CA (US); Shengzhi Wu, Belmont, CA (US)

(21) Appl. No.: 18/447,026

(22) Filed: Aug. 9, 2023

(51) Int. Cl. G06T 15/40; G06F 3/01; G06T 19/00

(52) U.S. Cl. CPC G06T 15/40; G06F 3/011; G06T 19/006; G06T 2200/24; G06T 2210/12; G06T 2210/21

(57) ABSTRACT

A method implemented by a computing device includes displaying on a display of the computing device an extended reality (XR) environment, and determining one or more virtual characteristics associated with a first virtual content and a second visual content viewable within the displayed XR environment, in which the second virtual content is at least partially occluded by the first virtual content. The method further includes generating, based on the one or more virtual characteristics, a plurality of user input interception layers to be associated with the first virtual content and the second visual content, and in response to determining a user intent to interact with the second virtual content, directing one or more user inputs to the second virtual content based on whether or not the one or more user inputs are intercepted by one or more of the plurality of user input interception layers.

### TECHNICAL FIELD

This disclosure generally relates to extended reality environments, and, more specifically, to the multi-layer and fine-grained input routing for extended reality environments.

### BACKGROUND

An extended reality (XR) system may generally include a real-world environment that includes XR content overlaying one or more features of the real-world environment. In typical XR systems,

Extended reality (XR) may include a form of reality that has been adjusted in some manner before presentation to a user, which may include, for example, a virtual reality (VR), an augmented reality (AR), a mixed reality (MR), a hybrid reality, or some combination thereof. Extended reality content may include completely generated content or generated content combined with captured content (e.g., real-world photographs). The extended reality content may include video, audio, haptic feedback, or some combination thereof, and any of which may be presented in a single channel or in multiple channels (such as stereo video that produces a three-dimensional effect to the viewer). Extended reality may be associated with applications, products, accessories, services, or some combination thereof, that may be used, for example, to create content in an extended reality or to perform activities in extended reality. The extended reality system that provides the extended reality content may be implemented on various platforms, including a head-mounted display (HMD) connected to a host computing device, a standalone HMD, a mobile device or computing device, or any other hardware platform capable of providing extended reality content to one or more viewers. In order for some extended reality applications, such as AR, to create a fully immersive and seamless experience for user, real-world objects and virtual objects within the user's environment may have to be seamlessly merged. For example, for the extended reality to be fully immersive and convincing to the user, real-world objects and virtual objects may have to interact in a realistic matter. It may thus be useful to provide techniques to improve XR systems and experiences.

### SUMMARY OF CERTAIN EMBODIMENTS

The present embodiments include techniques for directing user inputs to virtual content viewable to a user and partially occluded by other virtual content utilizing a number of user input interception layers. In certain embodiments, a computing device may display on a display of the computing device an extended reality (XR) environment. For example, in one embodiment, displaying on the display of the computing device the XR environment may include displaying the first virtual content, the second visual content, and a scene of real-world content, in which the scene of real-world content may be at least partially occluded by the first virtual content and the second virtual content. In certain embodiments, the computing device may then determine one or more visual characteristics associated with a first virtual content and a second visual content included within the displayed XR environment. In one embodiment, the second virtual content may be at least partially occluded by the first virtual content. In some embodiments, determining the one or more visual characteristics associated with the first virtual content and the second visual content may include determining one or more of a geometry, a size, a contour, a position, an orientation, a distance estimation, or one or more edges or surfaces of the first virtual content and the second visual content.

In certain embodiments, the computing device may then generate, based on the one or more visual characteristics, a number of user input interception layers to be associated with the first virtual content and the second visual content. For example, in some embodiments, the computing device may generate, based on the one or more visual characteristics, the number of user input interception layers by generating the number of user input interception layers utilizing one or more of a mesh collider generation algorithm, bounding box collider generation algorithm, or a volumetric collider generation algorithm. In one embodiment, at least one of the number of user input interception layers may be generated utilizing the mesh collider generation algorithm. In one embodiment, the mesh collider generation algorithm may be utilized to contour the at least one of the number of user input interception layers to the first virtual content and the second visual content. In certain embodiments, in response to determining a user intent to interact with the second virtual content, the computing device may direct one or more user inputs to the second virtual content based on whether the one or more user inputs are intercepted by one or more of the plurality of user input interception layers the computing device. For example, in some embodiments, the number of user input interception layers may include one or more of an occlusion collider, an object collider, a user interaction collider, or a user input blocking collider that may be associated with the first virtual content and the second virtual content.

In this way, the present embodiments may allow for directing user inputs to virtual content viewable to a user and partially occluded by other virtual content utilizing a number of user input interception layers. Indeed, by providing a number of user input interception layers including an occlusion collider, an object collider, a user interaction collider, and a user input blocking collider contoured and fitted to one or more occluded virtual content or virtual objects included within a scene of real-world content, the present embodiments may direct and rout user input in a manner that is more intuitive for the user (e.g., user can interact with all virtual content or virtual objects that is viewable to the user, whether occluded or not) and that allows the computing device to arbitrate user intent and/or user input in a manner that improves the overall XR experience of the user. The present techniques may further allow for the improvement of XR applications, such as dense multitasking, artistic-styled depth drawings, building and architectural design, real-medical procedures, and so forth.

The embodiments disclosed herein are only examples, and the scope of this disclosure is not limited to them. Certain embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example embodiment of an extended reality (XR) system.

FIG. 2 illustrates an example embodiment of an XR environment.

FIGS. 3A and 3B illustrate example XR experiences and, respectively.

FIG. 4 illustrates a flow diagram of a method for directing user inputs to virtual content viewable to a user and partially occluded by other virtual content utilizing a number of user input interception layers.

FIG. 5 illustrates an example computing device.

### DESCRIPTION OF EXAMPLE EMBODIMENTS

The present embodiments include techniques for directing user inputs to virtual content viewable to a user and partially occluded by other virtual content utilizing a number of user input interception layers. In certain embodiments, a computing device may display on a display of the computing device an extended reality (XR) environment. For example, in one embodiment, displaying on the display of the computing device the XR environment may include displaying the first virtual content, the second visual content, and a scene of real-world content, in which the scene of real-world content may be at least partially occluded by the first virtual content and the second virtual content. In certain embodiments, the computing device may then determine one or more visual characteristics associated with a first virtual content and a second visual content included within the displayed XR environment. In one embodiment, the second virtual content may be at least partially occluded by the first virtual content. In some embodiments, determining the one or more visual characteristics associated with the first virtual content and the second visual content may include determining one or more of a geometry, a size, a contour, a position, an orientation, a distance estimation, or one or more edges or surfaces of the first virtual content and the second visual content.

In certain embodiments, the computing device may then generate, based on the one or more visual characteristics, a number of user input interception layers to be associated with the first virtual content and the second visual content. For example, in some embodiments, the computing device may generate, based on the one or more visual characteristics, the number of user input interception layers by generating the number of user input interception layers utilizing one or more of a mesh collider generation algorithm, bounding box collider generation algorithm, or a volumetric collider generation algorithm. In one embodiment, at least one of the number of user input interception layers may be generated utilizing the mesh collider generation algorithm. In one embodiment, the mesh collider generation algorithm may be utilized to contour the at least one of the number of user input interception layers to the first virtual content and the second visual content. In certain embodiments, in response to determining a user intent to interact with the second virtual content, the computing device may direct one or more user inputs to the second virtual content based on whether the one or more user inputs are intercepted by one or more of the plurality of user input interception layers the computing device. For example, in some embodiments, the number of user input interception layers may include one or more of an occlusion collider, an object collider, a user interaction collider, or a user input blocking collider that may be associated with the first virtual content and the second virtual content.

In this way, the present embodiments may allow for directing user inputs to virtual content viewable to a user and partially occluded by other virtual content utilizing a number of user input interception layers. Indeed, by providing a number of user input interception layers including an occlusion collider, an object collider, a user interaction collider, and a user input blocking collider contoured and fitted to one or more occluded virtual content or virtual objects included within a scene of real-world content, the present embodiments may direct and rout user input in a manner that is more intuitive for the user (e.g., user can interact with all virtual content or virtual objects that is viewable to the user, whether occluded or not) and that allows the computing device to arbitrate user intent and/or user input in a manner that improves the overall XR experience of the user. The present techniques may further allow for the improvement of XR applications, such as dense multitasking, artistic-styled depth drawings, building and architectural design, real-medical procedures, and so forth.

As used herein, “extended reality” may refer to a form of electronic-based reality that has been manipulated in some manner before presentation to a user, including, for example, virtual reality (VR), augmented reality (AR), mixed reality (MR), hybrid reality, simulated reality, immersive reality, holography, or any combination thereof. For example, “extended reality” content may include completely computer-generated content or partially computer-generated content combined with captured content (e.g., real-world images). In some embodiments, the “extended reality” content may also include video, audio, haptic feedback, or some combination thereof, any of which may be presented in a single channel or in multiple channels (such as stereo video that produces a three-dimensional (3D) effect to the viewer). Furthermore, as used herein, it should be appreciated that “extended reality” may be associated with applications, products, accessories, services, or a combination thereof, that, for example, may be utilized to create content in extended reality and/or utilized in (e.g., perform activities) an extended reality. Thus, “extended reality” content may be implemented on various platforms, including a head-mounted device (HMD) connected to a host computer system, a standalone HMD, a mobile device or computing system, or any other hardware platform capable of providing extended reality content to one or more viewers.

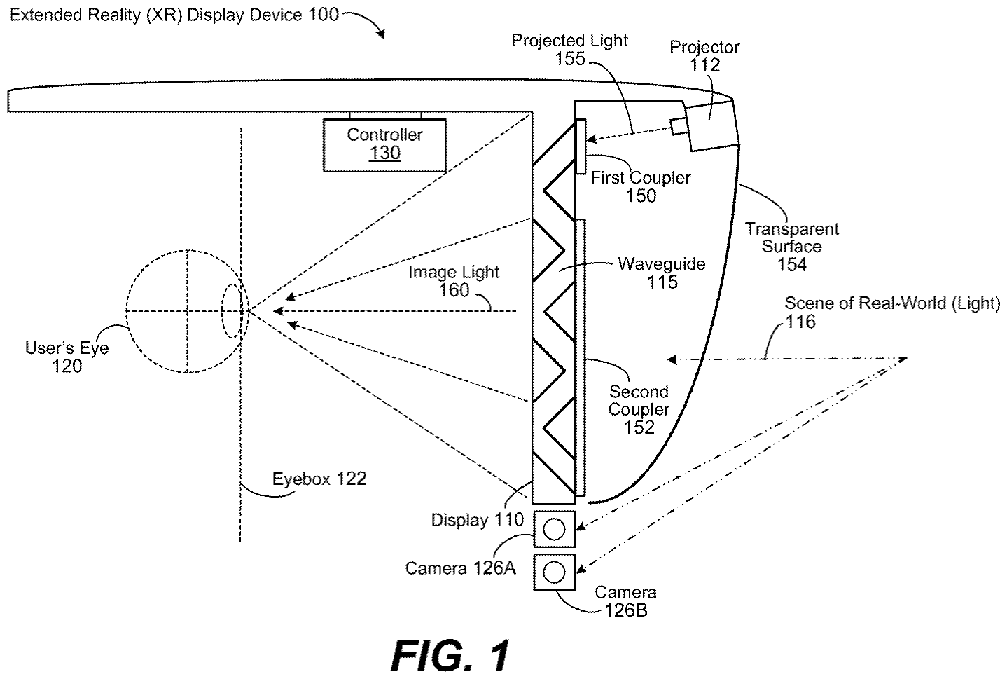

FIG. 1 illustrates a cross-section of an example XR display device 100, in accordance with the presently disclosed embodiments. The XR display device 100 includes an example wearable display 110, which may include at least one waveguide 115. It should be appreciated that the XR display device 100 as illustrated is an example of one embodiment of a head-mounted display (HMD) that may be useful in reducing energy consumption, in accordance with the presently disclosed embodiments. In another embodiment, the XR display device 100 may include a see-through HMD which may not include a waveguide and may instead render images directly onto, for example, one or more transparent or semi-transparent mirrors that may be placed in front of the eyes of a user, for example. FIG. 1 also shows an eyebox 122, which is a location where a user's eye 120 may be positioned with respect to the display 110 when the user wears XR display device 100. For example, as long as the user's eye 120 is aligned with the eyebox 122, the user may be able to see a full-color image, or a pupil replication directed toward the eyebox 122 by the waveguide 115. The waveguide 115 may produce and direct many pupil replications to the eyebox 122. The waveguide 115 may be configured to direct image light 160 to the eyebox 122 located proximate to the user's eye 120. For purposes of illustration, FIG. 1 shows the cross-section associated with a single user's eye 120 and single waveguide 115. In certain embodiments, the waveguide 115 or another waveguide may provide image light to an eyebox located at another eye of the user.

In certain embodiments, the waveguide 115 may be composed of one or more materials (e.g., plastic, glass, and so forth) with one or more refractive indices that effectively minimize the weight and widen a field of view (FOV) of the display 110. In one or more embodiments, the display 110 may include one or more optical elements between the waveguide 115 and the user's eye 120. The optical elements may act to, for example, correct aberrations in the image light 160, magnify the image light 160, make some other optical adjustment of the image light 160, or perform a combination thereof. Examples of optical elements may include an aperture, a Fresnel lens, a refractive (e.g., convex and/or concave) lens, a reflective surface, a filter, or any other suitable optical element that affects image light. The waveguide 115 may include a waveguide with one or more sets of Bragg gratings, for example.

In some embodiments, the display 110 that may include a scanline or one-dimensional (“ID”) waveguide display. In such an embodiment, a row of a light source may generate the light that is used to illuminate the entire vertical space (or horizontal space, where appropriate) of the display. Multiple smaller images may be combined to form a larger composite image as perceived by the viewer. A scanning element may cause the source light, treated by waveguide components, to be output to the user's eye 120 of the user in a specific pattern corresponding to a generation pattern used by the emitters to optimize display draw rate. For example, the light source may first be provided color values corresponding to a single row of pixels along the top of a display image.

In certain embodiments, the light may be transferred to the appropriate section of the eyebox 122 using a waveguide-based process assisted with a microelectromechanical system (MEMS)-powered oscillating mirror. After a short period of time, the light source may be provided color values corresponding to the next row of pixels (e.g., below the first). The light for this section of the image may then use the same process to position the color values in the appropriate position. Scanning displays may utilize less power to run and may generate less heat than traditional displays comprised of the same emitters. Scanning displays may have less weight as well, owing in part to the quality of the materials used in the scanning element and optics system. The frame rate of the display may be limited based on the oscillation speed of the mirror.

In other embodiments, the display 110 that may include a 2D or two-dimensional waveguide display. In such a display, no oscillating mirror is utilized, as a light source may be used that comprises vertical and horizontal components (e.g., in an array). Where the 1D variant lights the display on a row-by-row basis, the 2D variant may be capable of providing a significantly improved frame rate because it is not dependent on the oscillating mirror to provide for the vertical component of an image. To further improve the frame rate, the light source of a 2D waveguide display may be bonded to the controller and/or memory providing driving instructions for the display system. For example, the light source may be bonded to the memory that holds the color instructions for the display and/or the driver transistors. The result of such a configuration is that the light source for such a display may be operable with a considerably faster frame rate.

In certain embodiments, an XR display device 100 may include a light source such as a projector 112 that emits projected light 155 depicting one or more images. Many suitable display light source technologies are contemplated, including, but not limited to, liquid crystal display (LCD), liquid crystal on silicon (LCOS), light-emitting diode (LED), organic LED (OLED), micro-LED (μLED), digital micromirror device (DMD), any other suitable display technology, or any combination thereof. The projected light 155 may be received by a first coupler 150 of the waveguide 115. The waveguide 115 may combine the projected light 155 with a real-world scene 116 (e.g., scene light) received by a second coupler 152. The real-world scene 116 (e.g., scene light) may be, for example, light from a real-world environment, and may pass through a transparent (or semi-transparent) surface 154 to the second coupler 152. The transparent surface 154 may be, for example, a protective curved glass or a lens formed from glass, plastic, or other transparent material.

In certain embodiments, the coupling components of the waveguide 115 may direct the projected light 155 along a total internal reflection path of the waveguide 115. Furthermore, the projected light 155 may first pass through a small air gap between the projector 112 and the waveguide 115 before interacting with a coupling element incorporated into the waveguide (such as the first coupler 150). The light path, in some examples, can include grating structures or other types of light decoupling structures that decouple portions of the light from the total internal reflection path to direct multiple instances of an image, “pupil replications,” out of the waveguide 115 at different places and toward the eyebox 122 of the XR display device 100.

In certain embodiments, the scene light 116 may be seen by the user's eye 120. For example, as further depicted by FIG. 1, the XR display device 100 may include one or more cameras 126A and 126B. In certain embodiments, the one or more cameras 126A and 126B may include one or more color cameras (e.g., (R)ed, (G)reen, (B)lue cameras), one or monochromatic cameras, or one or more color depth cameras 126B (e.g., RGB-(D)epth cameras) that may be suitable for detecting or capturing the real-world scene 116 (e.g., scene light) and/or certain characteristics of the real-world scene 116 (e.g., scene light). For example, in some embodiments, in order to provide the user with an XR experience, the one or more cameras 126A and 126B may include high-resolution RGB image sensors that may be “ON” (e.g., activated) incessantly or temporarily, potentially during hours the user spends in extended reality, for example.

In certain embodiments, one or more controllers 130 may control the operations of the projector 112 and the number of cameras 126A and 126B. The controller 130 may generate display instructions for a display system of the projector 112 or image capture instructions for the one or more cameras 126A and 126B. The display instructions may include instructions to project or emit one or more images, and the image capture instructions may include instructions to capture one or more images in a successive sequence, for example. In certain embodiments, the display instructions and image capture instructions may include frame image color or monochromatic data. The display instructions and image capture instructions may be received from, for example, one or more processing devices included in the XR display device 100 of FIG. 1 or in wireless or wired communication therewith. The display instructions may further include instructions for moving the projector 112, for moving the waveguide 115 by activating an actuation system, or for moving or adjusting the lens of one or more of the one or more cameras 126A and 126B. The controller 130 may include a combination of hardware, software, and/or firmware not explicitly shown herein so as not to obscure other aspects of the disclosure.

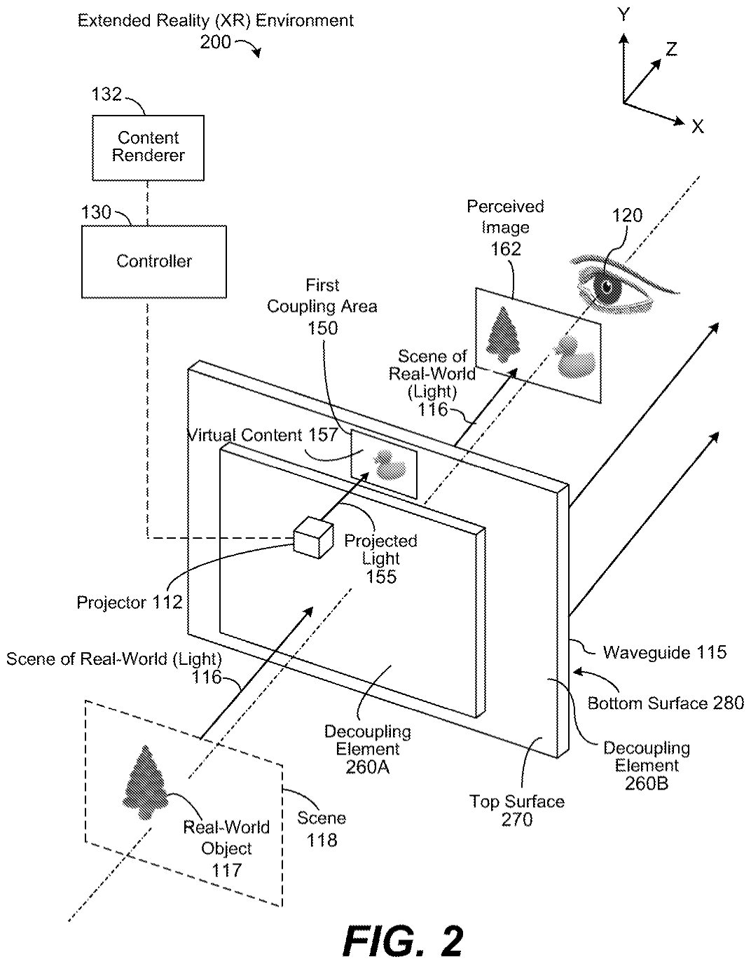

FIG. 2 illustrates an example isometric view of an XR environment 200, in accordance with the presently disclosed embodiments. In certain embodiments, the XR environment 200 may be a component of the XR display device 100. The XR environment 200 may include at least one projector 112, a waveguide 115, and a controller 130. A content renderer 132 may generate representations of content, referred to herein as AR virtual content 157, to be projected as projected light 155 by the projector 112. The content renderer 132 may send the representations of the content to the controller 130, which may in turn generate display instructions based on the content and send the display instructions to the projector 112.

For purposes of illustration, FIG. 2 shows the XR environment 200 associated with a single user's eye 120, but in other embodiments another projector 112, waveguide 115, or controller 130 that is completely separate or partially separate from the XR environment 200 may provide image light to another eye of the user. In a partially separate system, one or more components may be shared between the waveguides for each eye. In one embodiment, a single waveguide 115 may provide image light to both eyes of the user. Also, in some examples, the waveguide 115 may be one of multiple waveguides of the XR environment 200. In another embodiment, in which the HMD includes a see-through HMD, the image light may be provided onto, for example, one or more transparent or semi-transparent mirrors that may be placed in front of the eyes of the user.

In certain embodiments, the projector 112 may include one or more optical sources, an optics system, and/or circuitry. The projector 112 may generate and project the projected light 155, including at least one two-dimensional image of virtual content 157, to a first coupling area 150 located on a top surface 270 of the waveguide 115. The image light 155 may propagate along a dimension or axis toward the coupling area 150, for example, as described above with reference to FIG. 1. The projector 112 may comprise one or more array light sources. The techniques and architectures described herein may be applicable to many suitable types of displays, including but not limited to liquid crystal display (LCD), liquid crystal on silicon (LCOS), light-emitting diode (LED), organic LED (OLED), micro-LED (uLED), or digital micromirror device (DMD).

In certain embodiments, the waveguide 115 may be an optical waveguide that outputs two-dimensional perceived images 162 in the real-world scene 116 (e.g., scene light with respect to a scene object 117 and scene 118) directed to the eye 120 of a user. The waveguide 115 may receive the projected light 155 at the first coupling area 150, which may include one or more coupling elements located on the top surface 270 and/or within the body of the waveguide 115 and may guide the projected light 155 to a propagation area of the waveguide 115. A coupling element of the coupling area 150 may be, for example, a diffraction grating, a holographic grating, one or more cascaded reflectors, one or more prismatic surface elements, an array of holographic reflectors, a metamaterial surface, or a combination thereof.

In certain embodiments, each of the coupling elements in the coupling area 150 may have substantially the same area along the X-axis and the Y-axis dimensions, and may be separated by a distance along the Z-axis (e.g., on the top surface 270 and the bottom surface 280, or both on the top surface 270 but separated by an interfacial layer (not shown), or on the bottom surface 280 and separated with an interfacial layer or both embedded into the body of the waveguide 115 but separated with the interfacial layer). The coupling area 150 may be understood as extending from the top surface 270 to the bottom surface 280. The coupling area 150 may redirect received projected light 155, according to a first grating vector, into a propagation area of the waveguide 115 formed in the body of the waveguide 115 between decoupling elements 260.

A decoupling element 260A may redirect the totally internally reflected projected light 155 from the waveguide 115 such that the light 155 may be decoupled through a decoupling element 260B. The decoupling element 260A may be part of, affixed to, or formed in, the top surface 270 of the waveguide 115. The decoupling element 260B may be part of, affixed to, or formed in, the bottom surface 280 of the waveguide 115, such that the decoupling element 260A is opposed to the decoupling element 260B with a propagation area extending therebetween. The decoupling elements 260A and 260B may be, for example, a diffraction grating, a holographic grating, an array of holographic reflectors, etc., and together may form a decoupling area. In certain embodiments, each of the decoupling elements 260A and 260B may have substantially the same area along the X-axis and the Y-axis dimensions and may be separated by a distance along the Z-axis.

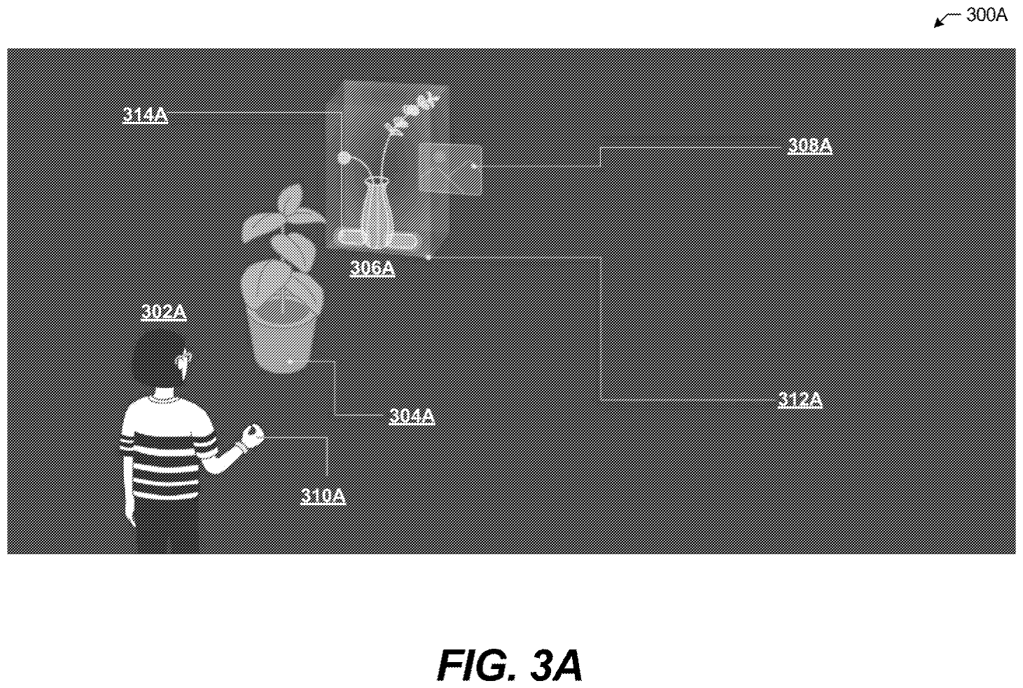

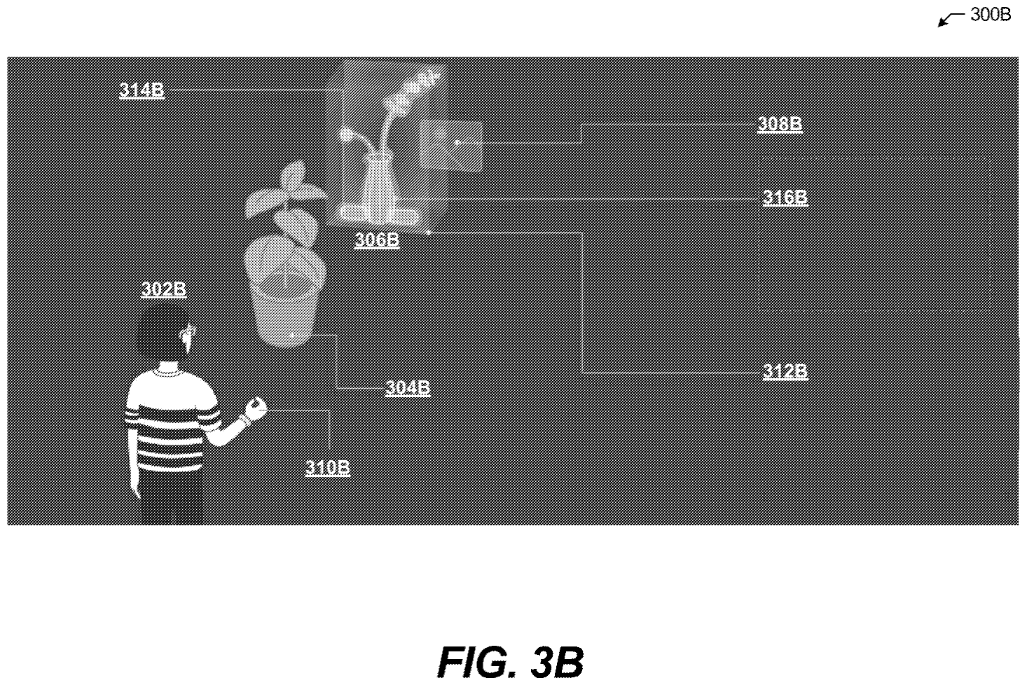

FIGS. 3A and 3B illustrate example XR experiences 300A and 300B, respectively, in accordance with the presently disclosed embodiments. For example, as depicted by FIG. 3A, a user 302A may place on a wearable XR display device, such as XR display device 100. In certain embodiments, the example XR experience 300A may include a scene of real-world content 304A (e.g., real-world object, such as a real-world potted plant), unoccluded virtual content 306A (e.g., partially unoccluded virtual object, such as a virtual flower and vase), and occluded virtual content 308A (e.g., e.g., partially occluded virtual object, such as a virtual picture). In certain embodiments, the scene of real-world content 304A (e.g., real-world potted plant) may partially occlude the unoccluded virtual content 306A (e.g., virtual flower and vase). Similarly, in certain embodiments, the unoccluded virtual content 306A (e.g., virtual flower and vase) may partially occlude the occluded virtual content 308A (e.g., partially occluded virtual picture). For example, in some embodiments, occlusions of virtual content by real-world content and/or virtual content by other virtual content may be performed, for example, utilizing one or more machine-learning model based or depth based techniques.

In certain embodiments, as further depicted by FIG. 3A, the unoccluded virtual content 306A (e.g., virtual flower and vase) may include one or more user input interception colliders 312A and 314A that may be associated with the unoccluded virtual content 306A (e.g., virtual flower and vase). In one embodiment, the user input interception collider 312A may include an object collider (e.g., a bounding box collider, a cylinder collider, a sphere collider, a capsule collider, and so forth) that may be suitable for detecting and defining virtual content-to-virtual content collisions. Similarly, in one embodiment, the user input interception collider 314A may include a user interaction collider that may be selected by the user 302A by way of one or more user inputs 310A (e.g., hand gestures, controller inputs, and so forth) to instantiate a set of options for interacting with the unoccluded virtual content 306A (e.g., virtual flower and vase). In certain embodiments, the user 302A may intend interact with one or more of the unoccluded virtual content 306A (e.g., virtual flower and vase) and the occluded virtual content 308A (e.g., virtual picture) by way of one or more user inputs 310A (e.g., hand gestures, controller inputs, and so forth).

In certain embodiments, when the user 302A intends to interact with the unoccluded virtual content 306A (e.g., virtual flower and vase), the XR display device 100 may direct the one or more user inputs 310A to the user input interception collider 312A or to the user input interception collider 314A. In accordance with the presently disclosed embodiments, when the user 302A intends to interact with the occluded virtual content 308A (e.g., virtual picture), the XR display device 100 may be unable to direct the one or more user inputs 310A to the occluded virtual content 308A (e.g., virtual picture) because any user inputs 310A intended to be directed to the occluded virtual content 308A (e.g., virtual picture) may be intercepted, for example, by the user input interception collider 312A. Thus, while the occluded virtual content 308A (e.g., virtual picture) may be viewable to the user 302A and the user 302A may intend to interact with the occluded virtual content 308A (e.g., virtual picture), the bulky size and geometry of the user input interception collider 312A may occlude the occluded virtual content 308A (e.g., virtual picture) in a manner, such that any user inputs 310A intended to be directed to the occluded virtual content 308A (e.g., virtual picture) may be intercepted by default. Further, because the user input interception collider 312A may be invisible to the user 302A, the XR experience of the user 302A may be adversely impacted because the user 302A cannot interact with all of the displayed virtual content.

In accordance with the presently disclosed embodiments, it may be thus useful to provide an additional or alternative user input interception collider 316B, as depicted by FIG. 3B. For example, in some embodiments, the user input interception collider 316B may include a user input blocking collider that may be generated to contour and near perfectly fit to the geometry, position, and orientation of the unoccluded virtual content 306B (e.g., virtual flower and vase) and/or the occluded virtual content 308B (e.g., virtual picture). In certain embodiments, the user input interception collider 316B may include, for example, a mesh input block collider that may be generated by the XR display device 100 utilizing one or more mesh collider generation algorithms or volumetric collider generation algorithms. For example, in some embodiments, the XR display device 100 may determine one or more visual characteristics of the unoccluded virtual content 306B (e.g., virtual flower and vase), the occluded virtual content 308B (e.g., virtual picture), or other virtual content to be rendered and displayed. For example, the one or more visual characteristics may include, for example, one or more of a geometry, a size, a contour, a position, an orientation, a distance estimation, or one or more edges or surfaces of the unoccluded virtual content 306A (e.g., virtual flower and vase), the occluded virtual content 308B (e.g., virtual picture), or other virtual content to be rendered and displayed.

In certain embodiments, the XR display device 100 may then utilize one or more mesh collider generation algorithms or volumetric collider generation algorithms to generate a user input interception collider 316B (e.g., user input blocking collider) that contours and near perfectly fits to the geometry, position, and orientation of the unoccluded virtual content 306B (e.g., virtual flower and vase), the occluded virtual content 308A (e.g., virtual picture), or other virtual content to be rendered and displayed. In one embodiment, the user input interception collider 316B (e.g., user input blocking collider) may replace altogether the user input interception collider 312B (e.g., object collider). In another embodiment, the user input interception collider 316B (e.g., user input blocking collider) and the user input interception collider 312B (e.g., object collider) may be utilized in conjunction, in which the user input interception collider 312B (e.g., object collider) may be dynamically enabled/disabled based on, for example, the use case and the desire of one or more software developers.

Thus, in accordance with the presently disclosed embodiments, when the user 302A intends to interact with the occluded virtual content 308B (e.g., virtual picture), for example, based on whether the one or more user inputs 310B are first intercepted by the user input interception collider 314B (e.g., user interaction collider) or the user input interception collider 316B (e.g., user input blocking collider), the XR display device 100 may direct the one or more user inputs 310B to the occluded virtual content 308B (e.g., virtual picture). For example, in one embodiment, when the one or more user inputs 310B are first intercepted by the user input interception collider 314B (e.g., user interaction collider), the XR display device 100 may process that the user 302B intends to interact with the unoccluded virtual content 306A (e.g., virtual flower and vase). In another embodiment, when the one or more user inputs 310B are first intercepted by the user input interception collider 316B (e.g., user input blocking collider), the XR display device 100 may process that the user 302B intends to interact with neither the unoccluded virtual content 306A (e.g., virtual flower and vase) nor the occluded virtual content 308B (e.g., virtual picture), and may simply ignore the one or more user inputs 310B.

On the other hand, when the one or more user inputs 310B are not intercepted by the user input interception collider 314B (e.g., user interaction collider) or the user input interception collider 316B (e.g., user input blocking collider), the XR display device 100 may process that the user 302B intends to interact with the occluded virtual content 308B (e.g., virtual picture). The XR display device 100 may thus direct or rout the one or more user inputs 310B to the occluded virtual content 308B (e.g., virtual picture). In this way, the present embodiments may allow for directing the one or more user inputs 310B to virtual content viewable to the user 302B and partially occluded by other virtual content utilizing a number of user input interception layers. Indeed, by providing a number of user input interception layers including an occlusion collider, an object collider, a user interaction collider, and a user input blocking collider contoured and fitted to one or more occluded virtual content or virtual objects included within a scene of real-world content, the present embodiments may direct and rout the one or more user inputs 310B in a manner that is more intuitive for the user 302B (e.g., user 302B is allowed to interact with all virtual content or virtual objects that is viewable to the user 302B, whether occluded or not) and that allows the XR display device 100 to arbitrate user intent and/or user input in a manner that improves the overall XR experience of the user 302B.

One or more running examples for directing user inputs to virtual content viewable to a user and partially occluded by other virtual content utilizing a number of user input interception layers, in accordance with presently disclosed embodiments. For example, an XR experience includes a scene of real-world content, a virtual user avatar, and a virtual object (e.g., virtual forest) that may be occluded by one or more real-world objects. A virtual holistic user experience (HUX) may occlude the virtual user avatar, and that may be further utilized by the user instantiate one or XR applications. There may be a virtual object (e.g., virtual dragon) that the user may select to interact with via user interaction collider. The user interacts with the virtual object (e.g., virtual dragon) and moves the virtual object (e.g., virtual dragon) to another location within the scene of real-world content. The virtual object (e.g., virtual dragon) moves into a position within the scene of real-world content, such that the virtual object (e.g., virtual dragon) at least partially occludes the virtual object (e.g., virtual forest).

In certain embodiments, as long as a user's gaze is focused onto a user input interception collider (e.g., user input blocking collider) that may be contoured and near perfectly fitted (e.g., indicated by fading edges) to the virtual object (e.g., virtual dragon) in accordance with the presently disclosed techniques, the user interaction collider may remain activated and the user may continue to be allowed to interact with the virtual object (e.g., virtual dragon). A user's gaze may be focused onto the virtual object (e.g., virtual forest), and thus the user inputs may no longer be intercepted by the user input interception collider (e.g., user input blocking collider) that may be contoured and near perfectly fitted to the virtual object (e.g., virtual dragon). A user interaction collider may then be activated to allow the user to interact with the virtual object (e.g., virtual forest). The user may then interact with the virtual object (e.g., virtual forest) by way of the user interaction collider. The user thus interacts with the virtual object (e.g., virtual forest) moves the virtual object (e.g., virtual forest) to another location within the scene of real-world content.

In this way, the present embodiments may allow for directing user inputs to virtual content viewable to a user and partially occluded by other virtual content utilizing a number of user input interception layers. Indeed, by providing a number of user input interception layers including an occlusion collider, an object collider, a user interaction collider, and a user input blocking collider contoured and fitted to one or more occluded virtual content or virtual objects included within a scene of real-world content, the present embodiments may direct and rout user input in a manner that is more intuitive for the user (e.g., user can interact with all virtual content or virtual objects that is viewable to the user, whether occluded or not) and that allows the computing device to arbitrate user intent and/or user input in a manner that improves the overall XR experience of the user. The present techniques may further allow for the improvement of XR applications, such as dense multitasking, artistic-styled depth drawings, building and architectural design, real-medical procedures, and so forth.

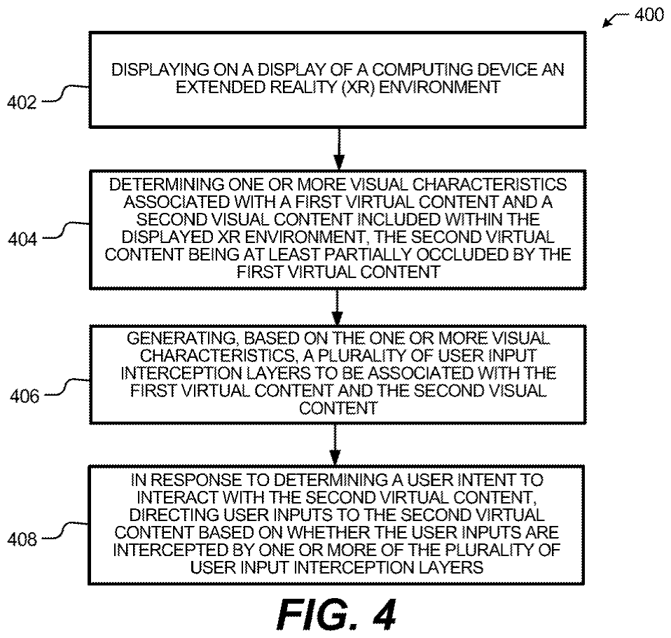

FIG. 4 illustrates a flow diagram of a method 400 for directing user inputs to virtual content viewable to a user and partially occluded by other virtual content utilizing a number of user input interception layers, in accordance with presently disclosed embodiments. The method 400 may be performed utilizing one or more processing devices (e.g., XR display device 100) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing image data), software (e.g., instructions running/executing on one or more processors), firmware (e.g., microcode), or some combination thereof.

The method 400 may begin at block 402 with one or more processing devices (e.g., XR display device 100) displaying on a display of a computing device an XR environment. The method 400 may then continue at block 404 with the one or more processing devices (e.g., XR display device 100) determining one or more visual characteristics associated with a first virtual content and a second visual content included within the displayed XR environment. For example, in one embodiment, the second virtual content may be at least partially occluded by the first virtual content. The method 400 may then continue at block 406 with the one or more processing devices (e.g., XR display device 100) generating, based on the one or more characteristics, a plurality of user input interception layers to be associated with the first virtual content and the second visual content. The method 400 may then conclude at block 408 with the one or more processing devices (e.g., XR display device 100) in response to determining a user intent to interact with the second virtual content, directing one or more user inputs to the second virtual content based on whether the one or more user inputs are intercepted by one or more of the number of user input interception layers.

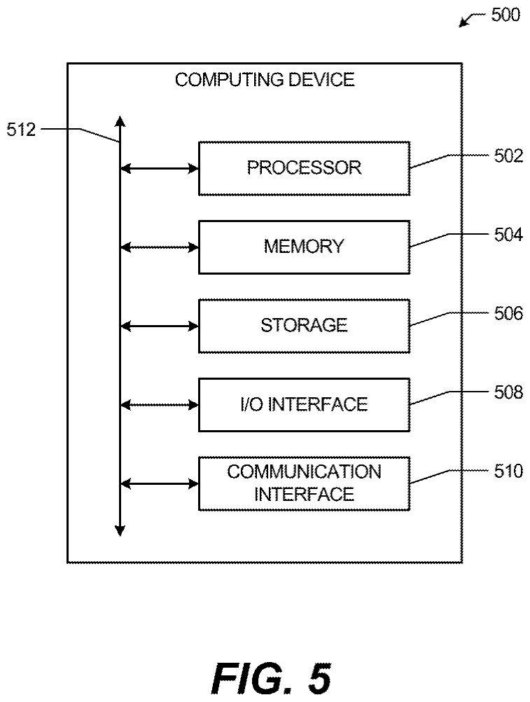

FIG. 5 illustrates an example computer system 500 that may be useful in performing one or more of the forgoing techniques as presently disclosed herein. In certain embodiments, one or more computer systems 500 perform one or more steps of one or more methods described or illustrated herein. In certain embodiments, one or more computer systems 500 provide functionality described or illustrated herein. In certain embodiments, software running on one or more computer systems 500 performs one or more steps of one or more methods described or illustrated herein or provides functionality described or illustrated herein. Certain embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein.

As an example, and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate. In certain embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In certain embodiments, processor 502 includes hardware for executing instructions, such as those making up a computer program. As an example, and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In certain embodiments, processor 502 may include one or more internal caches for data, instructions, or addresses. This disclosure contemplates processor 502 including any suitable number of any suitable internal caches, where appropriate. As an example, and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502.

Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In certain embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In certain embodiments, memory 504 includes main memory for storing instructions for processor 502 to execute or data for processor 502 to operate on. As an example, and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In certain embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere).

One or more memory buses (which may each include an address bus and a data bus) may couple processor 502 to memory 504. Bus 512 may include one or more memory buses, as described below. In certain embodiments, one or more memory management units (MMUs) reside between processor 502 and memory 504 and facilitate accesses to memory 504 requested by processor 502. In certain embodiments, memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In certain embodiments, storage 506 includes mass storage for data or instructions. As an example, and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In certain embodiments, storage 506 is non-volatile, solid-state memory. In certain embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In certain embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In certain embodiments, communication interface 510 includes hardware, software, or both providing one or more interfaces for communication (such as, for example, packet-based communication) between computer system 500 and one or more other computer systems 500 or one or more networks. As an example, and not by way of limitation, communication interface 510 may include a network interface controller (NIC) or network adapter for communicating with an Ethernet or other wire-based network or a wireless NIC (WNIC) or wireless adapter for communicating with a wireless network, such as a Wi-Fi network. This disclosure contemplates any suitable network and any suitable communication interface 510 for it.

As an example, and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In certain embodiments, bus 512 includes hardware, software, or both coupling components of computer system 500 to each other. As an example, and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates certain embodiments as providing particular advantages, certain embodiments may provide none, some, or all of these advantages.

1. A method, comprising, by a computing device:
displaying on a display of the computing device an extended reality (XR) environment;
determining one or more visual characteristics associated with a first virtual content and a second virtual content included within the displayed XR environment, the second virtual content being at least partially occluded by the first virtual content;
generating, based on the one or more visual characteristics, a plurality of user input interception layers to be associated with the first virtual content and the second virtual content; and
in response to determining a user intent to interact with the second virtual content, directing one or more user inputs to the second virtual content based on whether or not the one or more user inputs are intercepted by one or more of the plurality of user input interception layers.

2. The method of claim 1, wherein displaying on the display of the computing device the XR environment comprises displaying the first virtual content, the second virtual content, and a scene of real-world content, the scene of real-world content being at least partially occluded by the first virtual content and the second virtual content.

3. The method of claim 1, wherein determining the one or more visual characteristics associated with the first virtual content and the second virtual content comprises determining one or more of a geometry, a size, a contour, a position, an orientation, a distance estimation, or one or more edges or surfaces of the first virtual content and the second virtual content.

4. The method of claim 1, wherein generating, based on the one or more visual characteristics, the plurality of user input interception layers comprises generating the plurality of user input interception layers utilizing one or more of a mesh collider generation algorithm or a volumetric collider generation algorithm.

5. The method of claim 4, wherein at least one of the plurality of user input interception layers is generated utilizing the mesh collider generation algorithm.

6. The method of claim 5, wherein the mesh collider generation algorithm is utilized to contour the at least one of the plurality of user input interception layers to the first virtual content and the second virtual content.

7. The method of claim 1, wherein the plurality of user input interception layers comprises one or more of an occlusion collider, an object collider, a user interaction collider, or a user input blocking collider.

8. A computing device, comprising:
at least one display;
one or more non-transitory computer-readable storage media including instructions; and
one or more processors coupled to the at least one display, the one or more image sensors, and the storage media, the one or more processors configured to execute the instructions to:
display on the at least one display an extended reality (XR) environment;
determine one or more visual characteristics associated with a first virtual content and a second virtual content included within the displayed XR environment, the second virtual content being at least partially occluded by the first virtual content;
generate, based on the one or more visual characteristics, a plurality of user input interception layers to be associated with the first virtual content and the second virtual content; and
in response to determining a user intent to interact with the second virtual content, direct one or more user inputs to the second virtual content based on whether or not the one or more user inputs are intercepted by one or more of the plurality of user input interception layers.

9. The computing device of claim 8, wherein the instructions to display on the display of the computing device the XR environment further comprise instructions to display the first virtual content, the second virtual content, and a scene of real-world content, the scene of real-world content being at least partially occluded by the first virtual content and the second virtual content.

10. The computing device of claim 8, wherein the instructions to determine the one or more visual characteristics associated with the first virtual content and the second virtual content further comprise instructions to determine one or more of a geometry, a size, a contour, a position, an orientation, a distance estimation, or more edges or surfaces of the first virtual content and the second virtual content.

11. The computing device of claim 8, wherein the instructions to generate, based on the one or more visual characteristics, the plurality of user input interception layers further comprise instructions to generate the plurality of user input interception layers utilizing one or more of a mesh collider generation algorithm or a volumetric collider generation algorithm.

12. The computing device of claim 11, wherein at least one of the plurality of user input interception layers is generated utilizing the mesh collider generation algorithm.

13. The computing device of claim 12, wherein the mesh collider generation algorithm is utilized to contour the at least one of the plurality of user input interception layers to the first virtual content and the second virtual content.

14. The computing device of claim 8, wherein the plurality of user input interception layers comprises one or more of an occlusion collider, an object collider, a user interaction collider, or a user input blocking collider.

15. A non-transitory computer-readable medium comprising instructions that, when executed by one or more processors of a computing device, cause the computing device to:
display on a display of the computing device an extended reality (XR) environment;
determine one or more visual characteristics associated with a first virtual content and a second virtual content included within the displayed XR environment, the second virtual content being at least partially occluded by the first virtual content;
generate, based on the one or more visual characteristics, a plurality of user input interception layers to be associated with the first virtual content and the second virtual content; and
in response to determining a user intent to interact with the second virtual content, direct one or more user inputs to the second virtual content based on whether or not the one or more user inputs are intercepted by one or more of the plurality of user input interception layers.

16. The non-transitory computer-readable medium of claim 15, wherein the instructions to determine the one or more virtual characteristics associated with the first virtual content and the second virtual content further comprise instructions to determine one or more of a geometry, a size, a contour, a position, an orientation, or more edges or surfaces of the first virtual content and the second virtual content.

17. The non-transitory computer-readable medium of claim 15, wherein the instructions to generate, based on the one or more visual characteristics, the plurality of user input interception layers further comprise instructions to generate the plurality of user input interception layers utilizing one or more of a mesh collider generation algorithm or a volumetric collider generation algorithm.

18. The non-transitory computer-readable medium of claim 17, wherein at least one of the plurality of user input interception layers is generated utilizing the mesh collider generation algorithm.

19. The non-transitory computer-readable medium of claim 18, wherein the mesh collider generation algorithm is utilized to contour the at least one of the plurality of user input interception layers to the first virtual content and the second virtual content.

20. The non-transitory computer-readable medium of claim 15, wherein the plurality of user input interception layers comprises one or more of an occlusion collider, an object collider, a user interaction collider, or a user input blocking collider.
